(19) United States
(12) Patent Application Publication
(10) Pub. No.: US 2013/0188901 A1
(43) Pub. Date: Jul. 25, 2013

(54) THRUST BEARING FOR HYDRAULIC CONTINUOULSY VARIABLE TRANSMISSION

(71) Applicants: Chisato Tateyama, Kanagawa (JP); Masato Miyamoto, Kanagawa (JP)

(72) Inventors: Chisato Tateyama, Kanagawa (JP); Masato Miyamoto, Kanagawa (JP)

(73) Assignee: NSK LTD., Tokyo (JP)

(21) Appl. No.: 13/700,198

(22) PCT Filed: Jan. 26, 2012
(86) PCT No.: PCT/JP2012/051683

§ 371 Date: Nov. 27, 2012

(30) Foreign Application Priority Data
Aug. 29, 2011 (JP) 2011-186368

(51) Int. Cl. F16C 33/58; F16C 19/10

(52) U.S. Cl. CPC F16C 33/585; F16C 19/10
USPC 384/615

(57) ABSTRACT

The present invention provides a thrust bearing that is incorporated in a hydraulic continuously variable transmission, and includes: an inner ring that comes into contact with a piston of a piston chamber of a variable capacity pump; an outer ring that is fixed to a swash plate; and a plurality of rolling elements that are held between the inner ring and the outer ring via a cage, wherein: a groove bottom thickness (Ti) of the inner ring is 40% or more of a ball diameter; a groove bottom thickness (Te) of the outer ring is 15% or more of the ball diameter; and a ratio of (Ti/Te) is is more than 1 and less than 3. Thereby, damage of the inner ring is prevented, and thus a thrust bearing for a hydraulic continuously variable transmission of a long service life is provided.

### TECHNICAL FIELD

The present invention relates to a thrust bearing for a hydraulic continuously variable transmission.

### BACKGROUND ART

In agricultural machines such as combine harvesters and tractors, rice planting machines, and lawn mowers, the transition from gear transmission type to hydraulic continuously variable transmission type progresses. In such a hydraulic continuously variable transmission, a thrust bearing is adopted in a portion that receives a thrust pressure when converting rotational power of a shaft into an oil pressure, or when converting the oil pressure into the rotational power of the shaft (for example, see Patent Document 1).

### RELATED ART REFERENCE

### Patent Reference

Patent Document 1:JP-A-2003-194183

### SUMMARY OF THE INVENTION

### Problems to be Solved by the Invention

Recently, along with downsizing of the hydraulic continuously variable transmission, the thrust bearing incorporated thereto has been also downsized and has been used under high load conditions. Particularly, great load is applied to an inner ring of the thrust bearing that comes into contact with a piston of the hydraulic continuously variable transmission, and in some cases damage may occur.

The present invention has been made in the light of these circumstances, and an object thereof is to provide a thrust bearing for a hydraulic continuously variable transmission that prevents damage of the inner ring and has a long service life.

### Means for Solving the Problems

In order to achieve the object mentioned above, according to the present invention, there is provided a thrust bearing for a hydraulic continuously variable transmission. The thrust bearing is incorporated in a hydraulic continuously variable transmission, and includes an inner ring that comes into contact with a piston of a piston chamber of a variable capacity pump, an outer ring that is fixed to a swash plate, and a plurality of rolling elements that are held between the inner ring and the outer ring via a cage, wherein a groove bottom thickness (Ti) of the inner ring is 40% or more of a ball diameter, a groove bottom thickness (Te) of the outer ring is 15% or more of the ball diameter, and a ratio of (Ti/Te) is more than 1 and less than 3. Furthermore, it is preferable that an upper limit of the groove bottom thickness (Ti) of the inner ring be 1.2 to 1.5 times of 40% of the ball diameter, and an upper limit of the groove bottom thickness (Te) of the outer ring be 1.2 to 1.5 times of 15% of the ball diameter.

### Advantage of the Invention

In the thrust bearing for the hydraulic continuously variable transmission of the present invention, since the inner ring coming into contact with the piston of the piston chamber of the variable capacity pump of the hydraulic continuously variable transmission is thicker than the outer ring that is fixed to the swash plate, even if the bearing receives high load due to the piston, damage is suppressed, and the service life is lengthened. Furthermore, it is possible to make the height of the entire thrust bearing, including the inner ring, the outer ring and the ball, thinner, thus space-saving can also be achieved.

### BRIEF DESCRIPTION OF THE DRAWINGS

FIG. 1 is a cross-sectional view that illustrates an example of a hydraulic continuously variable transmission.

FIG. 2 is a cross-sectional view that illustrates a thrust bearing of the present invention.

### MODES FOR CARRYING OUT THE INVENTION

Hereinafter, a thrust bearing for a hydraulic continuously variable transmission of the present invention will be described with reference to the drawings.

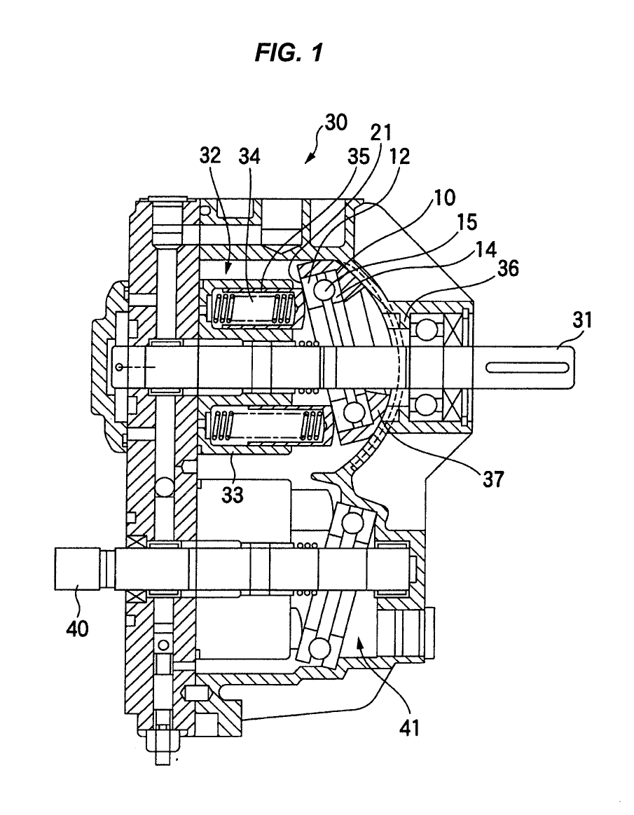

Although FIG. 1 is a cross-sectional view that illustrates an example of a hydraulic continuously variable transmission, a hydraulic continuously variable transmission 30 includes a variable capacity pump 32 that converts rotational driving force transmitted from an engine, not illustrated, to an input shaft 31 into hydraulic force, and a variable capacity motor 41 that returns the hydraulic power to the rotational driving force and transmits the rotational driving force to an output shaft 40. The hydraulic continuously variable transmission 30 continuously changes the rotational driving force transmitted to the input shaft 31 to driving force of a forward movement or a backward movement, and outputs the rotational driving force from the output shaft 40 or stops the output.

The variable capacity pump 32 includes a cylinder block 33 that is rotated integrally with the input shaft 31, nose pistons 35 that are placed at plural locations of the cylinder block 33 in a circumferential direction and reciprocates in a piston chamber 34, and a swash plate 37 that is rotated along a guide surface of the guide block 36. The variable capacity pump 32 changes a reciprocation movement stroke of the nose piston 35 by the rotation operation of the swash plate 37, and changes an oil quantity that is discharged from the piston chamber 34. A thrust bearing 10 is placed in the swash plate 37 at a position of coming into contact with a leading end portion of the nose piston 35, and the thrust bearing 10 is rotated together with the swash plate 37.

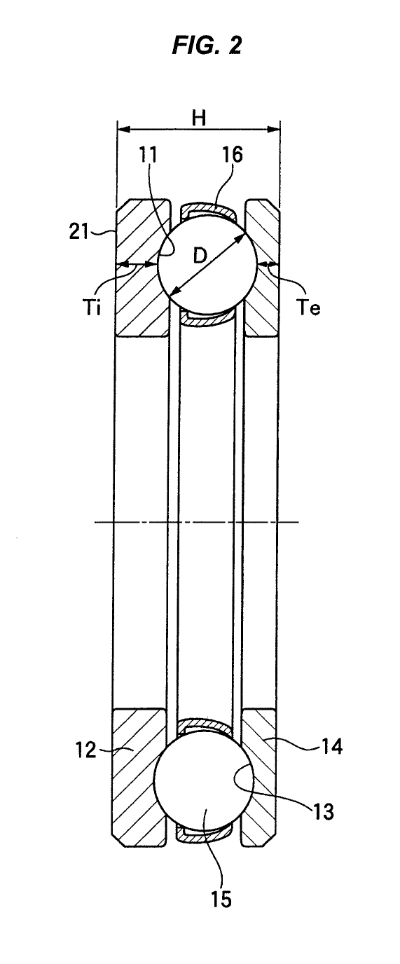

As illustrated in FIG. 2, in the thrust bearing 10, an inner ring 12 having an inner ring race surface 11 and an outer ring 14 having an outer ring race surface 13 are placed so as to face each other, and a plurality of balls 15 serving as rolling elements is placed between the inner ring race surface 11 and the outer ring race surface 13 in a rollable manner. Furthermore, the thrust bearing 10 includes a cage 16 that holds the plurality of balls 15 in the circumferential direction at equal intervals.

Furthermore, the inner ring 12 can be rotated, and leading end portion of the nose piston 35 comes into contact with an end surface 21 of a side opposite to a surface formed with the inner ring race surface 11.

Meanwhile, the outer ring 14 is fixed to the swash plate 37. For that reason, the thrust bearing 10 receives the high load, which is received from the nose piston 35, by the inner ring 12, and causes the high load to escape to the outer ring 14 side fixed to the swash plate 37 via the ball 15.

In the present invention, by making the inner ring 12, to which the high load is applied, thicker than the outer ring 14, durability with respect to the load from the nose piston 35 is increased, and thus damage is prevented. Specifically, the groove bottom thickness (Ti) of the inner ring 12 is set to be equal to or greater than 40% of the diameter (D) of the ball 15, the groove bottom thickness (Te) of the outer ring 14 is set to be equal to or greater than 15% of the diameter (D) of the ball 15, and the ratio of (Ti/Te) is set to be more than 1 and equal to or less than 3.

The dimensions mentioned above can be obtained by supporting both ends of the inner ring 12 or the outer ring 14 by the ball 15, assuming a beam that applies the load by the nose piston 35, and simulating a relationship of a material, a thickness, a load, and a bending stress of the inner ring 12 and the outer ring 14.

Specifically, when the inner ring 12, the outer ring 14 and the ball 15 are manufactured of SUJ 2, the diameter (D) of the ball 15 is set to 14.288 mm, and the load due to the nose piston 35 is 790 kgf/cm², the groove bottom thickness (Ti) is 40% or more compared to the diameter (D) of the ball 15 in the inner ring 12, and the groove bottom thickness (Te) is 15% or more compared to the diameter (D) of the ball 15 in the outer ring 14. Furthermore, when the ratio of (Ti/Te) is 2.67, it was calculated from the bending calculation that the inner ring 12 and the outer ring 14 would not fracture.

Furthermore, although there is no limit in an upper limit of the ratio to the diameter (D) of the ball 15, in the groove bottom thickness (Ti) of the inner ring 12, the groove bottom thickness (Te) of the outer ring 14, and, even if the thicknesses are unnecessarily increased, an increase in cost is caused. For that reason, in the groove bottom thickness (Ti) of the inner ring 12 and the groove bottom thickness (Te) of the outer ring 14, 1.2 to 1.5 times of the minimum thickness mentioned above are suitable.

Furthermore, with the dimensions mentioned above, it is possible to reduce the height (H) of the entire thrust bearing including the inner ring 12, the outer ring 14 and the ball 15, and space-saving can be achieved. Specifically, compared to a case where the inner ring 12 and the outer ring 14 are formed to have the same groove bottom thickness, in a case where the groove bottom thickness (Ti) of the inner ring 12 is set to 40% of the diameter of the ball 15, the groove bottom thickness (Te) of the outer ring 14 is set to 15% of the diameter of the ball 15, and the ratio of (Ti/Te) is set to 2.67, even if the height (H) of the entire thrust bearing is reduced by 15%, it is possible to prevent damage of the inner ring 12 by the same load.

Although the present invention has been described with reference to a specific embodiment, it will be apparent to those skilled in the art that various modifications and alterations can be made without departing from the spirit and the scope of the present invention.

The present invention is based on Japanese Patent Application No. 2011-186368 filed in the Japanese Patent Office on Aug. 29, 2011, the entire contents of which are incorporated herein by reference.

### INDUSTRIAL APPLICABILITY

The thrust bearing of the present invention may be used in agricultural machines such as combine harvesters and tractors, rice planting machines, and lawn mowers.

### DESCRIPTION OF REFERENCE NUMERALS AND SIGNS

10 thrust bearing
12 inner ring
14 outer ring
15 ball
16 cage
35 nose piston
30 hydraulic continuously variable transmission
Ti groove bottom thickness of inner ring
Te groove bottom thickness of outer ring

1. A thrust bearing, incorporated in a hydraulic continuously variable transmission, the thrust bearing including:
an inner ring that comes into contact with a piston of a piston chamber of a variable capacity pump;
an outer ring that is fixed to a swash plate; and
a plurality of rolling elements that are held between the inner ring and the outer ring via a cage, wherein:
a groove bottom thickness (Ti) of the inner ring is 40% or more of a ball diameter;
a groove bottom thickness (Te) of the outer ring is 15% or more of the ball diameter; and
a ratio of (Ti/Te) is more than 1 and less than 3.

2. The thrust bearing for a hydraulic continuously variable transmission according to claim 1, wherein:
an upper limit of the groove bottom thickness (Ti) of the inner ring is 1.2 to 1.5 times of 40% of the ball diameter; and
an upper limit of the groove bottom thickness (Te) of the outer ring is 1.2 to 1.5 times of 15% of the ball diameter.
